(19) United States
(12) Patent Application Publication
(10) Pub. No.: US 2004/0257361 A1
(43) Pub. Date: Dec. 23, 2004

(54) System, computer product, and method for creating and communicating knowledge with interactive three-dimensional renderings

(76) Inventors: Zale Lewis David Tabakman, Toronto (CA); Jacob David Farber, Thornhill (CA)

Correspondence Address: MILLER THOMPSON, LLP, 20 QUEEN STREET WEST, SUITE 2500, TORONTO, ON, M5H 3S1, CA

(21) Appl. No.: 10/868,875

(22) Filed: Jun. 17, 2004

Related U.S. Application Data
(60) Provisional application No. 60/478,837, filed on Jun. 17, 2003.

(51) Int. Cl. G06T 17/00; G06T 15/00

(52) U.S. Cl. 345/419; 345/619

(57) ABSTRACT

The present invention consists of a method for creating three-dimensional renderings. The method includes defining one or more documents required to render a three-dimensional object, or process involving the three-dimensional object, the three-dimensional object or the process involving the three-dimensional object defining a three-dimensional rendering; creating one or more documents in collaboration with one or more individuals with subject matter expertise related to the three-dimensional rendering; creating a three-dimensional rendering based on the one or more documents; and validating the three-dimensional rendering by the one or more individuals with subject matter expertise. A related method for creating photo-realistic three-dimensional representations of non-organic and organic three-dimensional objects is also provided. The invention also consists of a computer system and a computer program for creating interactive three-dimensional renderings. One aspect of the computer system and the computer program is a workflow management utility for managing the workflow related to the creation of the interactive three-dimensional renderings; another aspect is a rendering application development facility operable to extract one or more data elements from work product created by the workflow management utility and define a three-dimensional rendering application based on the data elements.

### FIELD OF THE INVENTION

The invention relates generally to the creation of three-dimensional computer-implemented renderings of real world objects to address problems communicating knowledge about these objects. This invention further relates to technology solutions that enable interaction with three-dimensional renderings of objects.

### BACKGROUND OF THE INVENTION

An interactive three-dimensional rendering is a computer generated presentation of a real life physical object that enables the viewer to watch the object move, watch the object operate, watch multiple objects, and enable a user to interact with the object. The interaction generally includes enabling the viewer to select any viewing angle or viewing magnification, and enable the viewer to select objects in the viewing space to appear, not appear, or appear in a translucent state.

Additional interactions enable a user to manipulate the objects in a particular position and orientation in a three-dimensional environment or populated by itself or with other objects.

The interactions include information co-ordinates with the rendering being presented using text, audio, or video.

Three-dimensional renderings can be generally used in simulations for teaching, for product sales, and to assist repairs, as well as other applications.

It should be expressly understood that the singular term “object” is only used for descriptive purposes and can also refer to multiple objects moving as a group or multiple objects interacting with each other.

It should be expressly understood that the singular term “individual” is only used for descriptive purposes and can also refer to multiple individuals acting each acting independently, a number of individuals acting in concert, a corporation, or a country. Numerous approaches exist that let individuals pass knowledge about an object between people who are at a distance from one another. For example, American sellers of mining equipment selling to Brazilian purchasers, American car manufacturers training automobile mechanics in China. A general approach is travel by either party to the one of the party's physical location, or a visit to a common location such as a trade show or a site where the product is being used. Other approaches include video and printed documentation. The disadvantages of video and print is explained below. A disadvantage of the travel based approach is the economic cost of transporting the goods and people over distances. This can be very costly for goods in particular that are large and heavy. A further disadvantage is the time lost in travel of any of the individuals involved. A further disadvantage is that there may be a number of people who need to understand the knowledge, but for any number of reasons these people can not do the travel as required.

Therefore, there is a need for a method, system, and computer product that is able to present goods across disparate locations in many different contexts, on an economical basis.

It is understood that individuals may not have access at all times to a digital computer to view the three-dimensional renderings, therefore a method, system and computer program is needed to transfer knowledge that is stored in a three-dimensional rendering in a manner that is consistent with the three-dimensional rendering. Products are now generally sold around the world to purchasers who generally speak only one language and that language may in many cases be different than the manufacturer's language. For economic reasons, it is common for a group of diagrams to be used to demonstrate a procedure related to a product. The instructions that explain the procedure are presented only with symbols and no language. Another approach is to have a separate guide for each of the different languages. A final approach is to have a separate guide for each language. Each language description generally references the diagram. A disadvantage of using only symbols is that the symbols can sometimes be confusing to some individuals. The disadvantage of the separate language guides is that references to the common diagrams must ensure the diagram numbering is consistent. The disadvantage of the last approach is that the guides are often not-cost effective to produce.

Therefore there is a need for a method, system, and computer program that allows instruction guides to be produced an economical basis in multiple languages in a form consistent with three-dimensional renderings.

Therefore there is also a need for a method, system, and computer program that allows instruction guides to be produced that ensures the text is consistent with the diagrams.

Numerous technologies exist that enable the creation of three-dimensional computer-implemented renderings of real life physical objects that further enable interaction therewith in cooperation with a computer. However, as illustrated below, there are disadvantages in using such prior art technologies for the purpose of creating three-dimensional computer-implemented rendering of physical objects permitting effective interactions therewith, on an economic basis.

For example, there exist three-dimensional digitizers that create realistic looking three-dimensional models using digital images for the textures. The Minolta VIVID 300™ is an example of this.

The main disadvantage of three-dimensional digitizer technologies and techniques is that they create digital models with too much detail and the resultant files are generally too large and complex to be used for creating three-dimensional renderings. “Computer Assisted Design” or “CAD” tools are well known for creating data objects that in conjunction with other programs such as Windows™ Media Player to enable interactions with three-dimensional renderings to be viewed. Other technologies, such as APPLE'S QUICKTIME VR™, simulate the effect of 3D by allowing an object to be turned and viewed from different angles. Other technologies, such as CYCORE DESIGNER™ enable three-dimensional renderings to be manipulated.

The main disadvantage of technologies and techniques that enable the creation of digital images using CAD tools and other similar tools is that typical three-dimensional renderings are relatively lacking in authenticity, as compared to the real three life objects that the three-dimensional renderings represent. This decreases the similarity of interactions with the three-dimensional computer-generated renderings with interaction with the real object. A further disadvantage is that the CAD tools and similar tools is that any movement of the object is generally limited to a predefined pattern.

A further disadvantage of prior art solutions is that three-dimensional renderings using tools such as APPLE'S QUICKTIME VR™ technology, is that they generally only enable rotation of three-dimensional renderings in a limited number of orientations. This limits the nature of interactions with the three-dimensional renderings, and therefore decreases the similarity of the interactions with interactions with the real object. A further disadvantage with this type of technology is that any viewing movement is often limited to a predefined position at pre-defined magnifications.

Computer renderings of three-dimensional objects using known computer animation tools generally improve on the authenticity achieved using the CAD type tools. However, the disadvantage of such computer animations is that it is generally time consuming to create same, and further they are costly. In addition, even state of the art computer rendering tools lack authenticity, especially in relation to physical objects where texture, for example, is an important visual attribute thereof.

A further disadvantage of CAD based solutions is that they generally require a number of highly trained experts to produce the results in a timely fashion.

A further disadvantage of all these solutions is that they are generally limited to the movement of the object itself and do not address the communications usually needed in relation to such object for the purposes described. Therefore these solutions do not generally provide an economic solution for the general objects of this invention.

There is a need therefore for a system, computer product and method that enables the creation of three-dimensional renderings of physical objects that supports interactions with the renderings wherein the interactions provide a relatively close match with interactions with the physical objects. There is a further need for such a system, computer product and method that is relatively cost effective such that it can be deployed in numerous software applications.

There is a still further need for such a system, computer product and method that is relatively easy to implement.

Numerous technologies are available for individuals from many different occupations or skill sets who need knowledge of a real world object and its movement. These technologies include video tapes, manuals, internet training courses, and live demonstrations. Knowledge transfer related to such products need generally include but is not limited to (1) why the object is advantageous; (2) why the object is advantageous to alternatives, both similar and dissimilar; (3) how the object operates; (4) how the object is installed; (5) how the object is repaired; (6) how the object is maintained; and (7) how the object is replaced;

The main disadvantage of all these types of technologies is that the viewing position or magnification is fixed at the time of the creation of the demonstration. Therefore, if a person needs to change the viewing angle or increase the magnification, generally a substantial amount of the materials needs to be reproduced. This is generally expensive.

A further disadvantage of these techniques is that if the procedure changes even slightly, a substantial economic loss is incurred in re-creating and distributing the materials.

A further disadvantage of video is that it captures everything. This is a problem for example in medical procedures. Some individuals find the presentation of a surgical procedure with all the associated blood to be very difficult to watch and learn as a result.

Therefore, there is a need for a method, system, and computer program that allows the realistic presentation of a procedure that allows selection of parts of the procedure. Furthermore, the selection of the procedure needs to be done in a cost effective manner.

A further disadvantage of these techniques is that if there are often changes to the procedure and if the new updated procedures are not available to all concerned individuals in a timely manner, then substantial loss can occur. For example, if the original procedure for the repair of an airplane was incorrect, there is the possibility that the incorrect repair instructions can cause economic loss, destruction of property, injury to a person, or loss of human life.

A further disadvantage of these techniques is that during the presentation of the procedure, one of the objects may block the viewing angle of another object. For example, when viewing the procedure for “unplugging a drain with a snake”, it is physically difficult to understand how the “snake” enters the drain, as the drain will block the view of the “snake” doing its work.

There is therefore a need for a method, system and computer product that will enable a procedure to be demonstrated from any viewing angle or magnification, allow objects within the image to be displayed or not displayed, enable such a demonstration to be updated relatively inexpensively, the updates distributed at a low cost, and provide a mechanism that will allow the viewer to ensure they have the most up to date and accurate set of procedure instructions.

Simulated physical objects are used to inform individuals about how to use the objects. For example, automobile repair is done with car parts, medical students use plastic models or cadavers, engineers use wood for bridge models; and astronauts' train with physical simulators.

There is a disadvantage of these simulation technologies is that they are usually expensive to use and operate and are not available for ad-hoc review of the procedure, for example in the home or when traveling on an airplane.

There is a further disadvantage of these simulation technologies in that they generally do not provide additional information when the training is occurring. For example, plastic models generally do not provide a running audio commentary.

There is a further disadvantage that every individual generally needs their own simulator or physical object.

There is a further disadvantage that some simulations will damage the simulator and a new simulator is required for each simulation.

Therefore there need for such a system, computer product, and method that the different types of knowledge about physical objects that is most effectively transferred using movement and interaction that is portable, realistic, and cost effective.

Creation of a realistic three-dimensional rendering generally involves ensuring adherence with strict quality control standards, whereby failure to comply with such standards in an earlier stage can affect quality of the rendering downstream, resulting in important waste of resources.

Creation of a realistic three-dimensional rendering also generally requires the collaboration of more than one individual, particularly where properly reflecting the reality of a procedure rendered using the rendering requires the input of subject matter experts. For example, in the case of a rendering of a complicated surgical procedure, involvement of numerous different medical experts and medical device experts may be required to provide a realistic rendering. Skilful operation of particular tools required for particular steps of the imaging process may require specialized knowledge, or creation of digital images of physical objects may require photographic skills not generally possessed by software specialists dealing with other aspects of the workflow.

As a consequence of the above, the creation of three-dimensional renderings as described herein often requires collaboration between a relatively large number of individuals.

Various solutions are known for scheduling of resources. One example is MICROSOFT PROJECT™ which is a software program to manage schedules, tasks and resources. Tasks are assigned to resources and estimates are provided to these tasks.

While such resource scheduling tools can be used in support of the creation of three-dimensional renderings, or modified to support such three-dimensional renderings, they do not generally enable the effective handling of the volume of unique items that need to be scheduled. An expert in the use of project management software is typically required to manage and track projects of the magnitude generally involved in creating three-dimensional renderings.

A further disadvantage of resource scheduling tools is that they require an expert to add or remove tasks as the specifications of the project expand or contract causing an economic disadvantage and introducing the possibility of error.

There is a need therefore for a system and computer product that enables easy use of resource scheduling for the purpose of the creation of the three-dimensional renderings described herein by the various individuals who generally collaborate in typical projects of this type.

Solutions for identifying and tracking deliverables in a process workflow are also known. An example of such a solution is MICROSOFT EXCEL™. EXCEL™ enables an alternate method for (a) estimating the project cost, (b) tracking the deliverables, (c) and managing the issues identified in a project workflow. However, the volume of work product involved in delivering a typical three-dimensional rendering described herein generally requires a person with relatively considerable expertise in the use of spreadsheet software so as to ensure all information is accurately tracked. It is preferable from a resource management perspective that the various individuals usually involved in the creation of a three-dimensional rendering be able to use the deliverable identification and tracking tools. Otherwise constant interfacing would be required with a project manager or project management team which may be cumbersome, time consuming and result in errors.

Another disadvantage of these kinds of systems is that there is no known predefined automated way for adding or removing deliverables on a specific project without the use of an expert.

There is a need therefore for a system and computer product that enables the easy use of a solution for identification and tracking of deliverables in support of a workflow related to the creation of a three-dimensional rendering.

There is a need therefore for a system and computer product that enables the automated adding and removing of deliverables to a project deliverable list as project deliverables are specified, reviewed, and completed.

Issue tracking tools are also known. These technologies generally compare workflow items against a series of criteria generally corresponding with work flow related specifications. These specifications may relate to a number of issues including quality assurance. An example of such an issue tracking tool includes NetResults PROBLEMTRACKER™. PROBLEMTRACKER™ provides software utilities to manage the issue from creation through resolution.

The disadvantage of such issue tracking tools is that they are generally generic in nature and are not particularly simple to customize to support the creation of three-dimensional renderings. Another disadvantage of such prior art issue tracking tools is that their functions do not lend themselves easily to the typical workflow of a three-dimensional rendering.

There is a need therefore for an issue tracking system specific for three-dimensional rendering. This is best understood by illustration of an example. A complex piece of anatomy and the related medical technology consists of a large number of unique components, which must be reviewed and approved by subject experts who are extremely limited in their availability and time. For example, in a medical procedure an expert could include an oncologist, a neuro-physiologist, and a neurosurgeon. The review process has a large number of different parameters for verification. Variance from the standard needs to be applied to each parameter. A process that minimizes the time requirements for the resources and ensures that all issues are correctly identified is required. While at this time a number of standard parameters are known for three-dimensional renderings, specific project parameters will develop and undoubtedly the experts will identify other parameters to measure accuracy. Standard parameters include accurate shape, proportional size, color, surface detail, position of detail. For example on a brain, project parameters could include naming conventions as. per different anatomy atlases. These parameters apply to the various Gyrus and fissures across the brain.

Another aspect of the creation of three-dimensional renderings, is that they can be relatively costly to produce. Their creation for third parties generally involves providing a quote on the overall project. This requires careful scoping of the overall project, and then careful control of costs involved in the project by tracking any expansion of the scope.

There is therefore a further need for a system and computer product that enables work product and work processes used to create the interactive three-dimensional renderings described herein.

There is a need therefore for a system and computer product that enables an automated method for tracking and management of deliverable issues to project specifications for the creation of three-dimensional renderings.

There is a still further need for a costing mechanism that is integrated with the method described for creation of three-dimensional renderings.

It is known that individuals gain knowledge (learn) in different ways, through sound, through visual aids, and through experimental effort. The disadvantages of current technologies (video, simulators, etc.) has been explained above. Furthermore, individuals learn at different rates. A further disadvantage of these technologies is that they generally do not allow the individual to feel fully in control of the knowledge transfer.

Therefore, there is a need for a method, system, and computer product that will provide sound, visual and experimental knowledge transfer in an economic manner.

Furthermore, there is a need that allows an individual to structure the knowledge transfer, move at their own pace, fully control the viewing angle and magnification they choose, stop, back-up and so on so that the individual feels fully in control and will be able to maintain interest.

In many large organizations, there is often a lack of integration of promotional materials, sales training materials, product installation materials, product repair materials, and customer support materials. Furthermore, the materials used in the internet and in print form are generally created separately and independently. In general, these materials are created independent of one and another.

Therefore, there is also a need for a method, system, and computer product that will allow materials from different parts of the company to be integrated and shared between the different business segments.

Introducing an innovative product into the marketplace can be risky from an economic stand point. Showing a novel design or explaining functionality that has never existed before is difficult, as individuals must learn the new functionality. The general approach is to demonstrate the product face-to-face with potential purchasers, individuals in the media, and create a large advertising campaign. The disadvantage of this method is the economic cost involved.

Therefore, there is a need for a method, system, and computer product that will assist in the demonstration and explanations of products that has economic benefit in that it helps promote acceptance of new products.

Some procedures are much more easily understood when seen than when described. It is the current practice that companies have a telephone based help desk. Telephone based help generally is used to answer queries about how to perform a particular action with a product. The person answering the query may have to describe in words what the person making the query must do. There are generally two major disadvantages. It is hard for some individuals to describe the procedure in an understandable way (e.g.: turn the blue gizmo to the right) and it is difficult for individuals to understand the instructions. A further disadvantage is that it is expensive and time consuming to train an individual on all the possible procedures. A further disadvantage is when the product has small variations (e.g.: color, labels, and attached options) it may be more difficult for some individuals to understand the procedure. A further disadvantage is when the individual asking the question may not be able to describe their problem fully as they cannot articulate the names of the parts of a device. A further disadvantage is that it is becoming increasingly difficult and costly to recruit and retain qualified individuals to answer the questions, and the associated training costs are high. A further disadvantage of the current methods is that the number of products needing support is significantly high, and it is difficult to ensure the individual who answers the questions is doing so correctly and consistently.

Therefore, there is a need to for a method, system, and computer product that will help a customer service representative explain products and answer questions and discuss a problem or procedure in a cost effective manner.

There is a still further need for a presentation method for interacting with the three-dimensional renderings for the purposes of transferring knowledge.

### SUMMARY OF THE INVENTION

It is one object of the present invention to provide a method for creating three-dimensional renderings of physical objects that support user interactions. The method generally consists of a series of steps which in combination provide a methodology for providing realistic three-dimensional renderings of different physical objects, such that the three-dimensional renderings in each case support the purpose of the interactions for which they are created.

In one aspect of the present invention, a method is provided for creating realistic three-dimensional renderings of a range of objects having different physical attributes.

In a still other aspect of the present invention, a system, computer product and method is provided for using a computer implemented solution for practicing the three-dimensional model creation method of the present invention.

In another aspect of the present invention, a system, computer product and method is provided for specifying the details of what the final result will require and will be included in the final three-dimensional rendering created.

In another aspect of the present invention, a system, computer product and method is provided that enables communication of knowledge and operation using three-dimensional renderings.

Yet another aspect of the present invention is a system, computer product and method that enables a person to communicate sales material to others that includes a representation of a physical product, including a procedure involving a physical object.

A still further aspect of the present invention is a system and computer product that uses three-dimensional renderings allowing (1) comparison of one or more real-world objects; (2) demonstrating the object's physical, operational, and practical advantages in an absolute form or in a form relative to other objects; (3) illustrating operation of the object; (4) showing installation of the object; (5) depicting repair of the object; (6) teaching maintenance; and (7) replacement of the object.

A still further aspect of the present invention is a system and computer product that uses three-dimensional renderings to test a person's knowledge about an object. The testing can include any aspect of the knowledge provided about the object.

A still further aspect of the present invention is a system and computer product that provides a workflow management facility that enables the management of the workflow, including by multiple individuals, in order to provide the three-dimensional renderings of the invention.

A still further aspect of the present invention is a system and computer product that provides a method for a customer or specialist to provide review and feedback on the three-dimensional rendering based on work-in-progress or when deliverables are completed.

As a still further aspect of the invention the workflow management facility includes a project estimate facility that assists in the creation of cost estimates for creation of one or more three-dimensional renderings.

### BRIEF DESCRIPTION OF THE DRAWINGS

A detailed description of the preferred embodiment(s) is(are) provided herein below by way of example only and with reference to the following drawings, in which:

FIG. 1 is a flowchart that illustrates the steps involved in the method of the present invention for creating three-dimensional rendering method of the present invention.

FIG. 2 if a further flowchart that illustrates another embodiment of the method of creating three-dimensional renderings of physical objects in accordance with the present invention.

FIG. 3 is a system resource chart illustrating the resources of the of the present invention for implementing the three-dimensional model rendering method of the present invention.

FIG. 4 is a program resource chart illustrating the resources of a computer product of the present invention for creating and publishing the three-dimensional rendering created in accordance with the present invention, via IP networks.

FIG. 5 is a program resource flowchart that illustrates the principal resources of the computer product of the present invention for interacting with three-dimensional renderings created in accordance with the present invention, via IP networks.

FIG. 6 is a database diagram that illustrates the principal database entities of the computer product of the present invention for managing and publishing three-dimensional renderings created in accordance with the present invention, via IP networks.

FIG. 7 is a database diagram that illustrates the principal database entities of the computer product of the present invention for interacting with the three-dimensional renderings created in accordance with the present invention, via IP networks.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

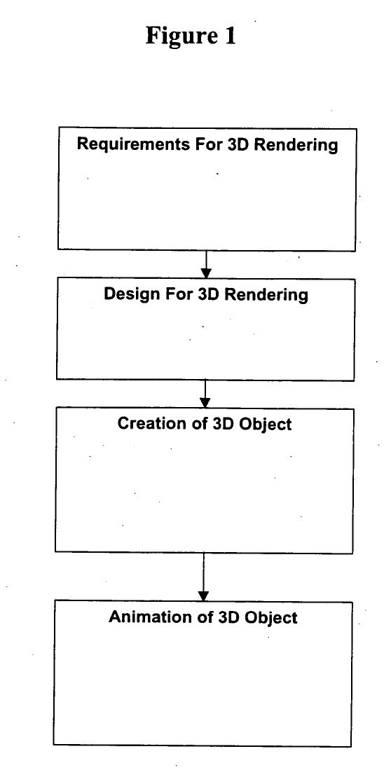

The present invention consists of a plurality of steps for creating three-dimensional renderings of physical objects or procedures including physical objects. These steps are further directed to communicating based on predetermined objectives using such three-dimensional renderings. The method is also directed to implementing software, namely a client computer product, for communicating knowledge using the three-dimensional renderings. The method of the invention is illustrated in,FIG. 1.

The principal steps of one aspect of the present invention include (1) establishing requirements for three-dimensional rendering; (2) design for three-dimensional rendering; (3) creation of three-dimensional object; and (4) animation of a three-dimensional object to produce a three-dimensional rendering.

It should be understood that the sequence of the steps of the present invention described herein, unless provided otherwise, are not essential. One or more of the steps may be combined, or separated into a plurality of discreet steps without departing from the invention.

It should be understood that some of the interactions described involve interactions between more than one physical object, say for example between a surgical implement and an organ in a surgical-operation. In these particular interactions, in accordance with the present invention, three-dimensional renderings are created for each of the physical objects in order to create a rendering of their interaction.

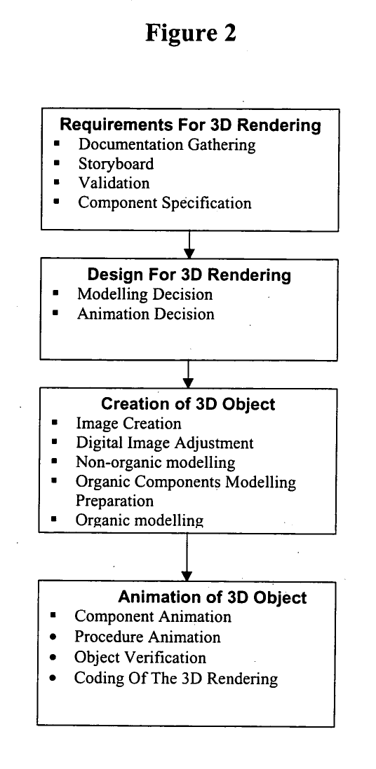

It should be understood that the examples used in this disclosure are intended to demonstrate the contemplated modifications of the present invention. As illustrated in FIG. 2, the principal steps of the present invention described above are then sub-divided into further steps.

### Requirements for Three-Dimensional Rendering

The first step of the present invention is establishing the requirements for a particular three-dimensional rendering, created in accordance with the present invention.

Documentation Gathering

In one aspect of establishing these requirements, “Documentation Gathering” is undertaken. This documentation generally consists of information that relates to interaction with a physical object, namely interaction that is the object of the interactive three-dimensional rendering that is provided in accordance with the present invention.

It should be understood that the present invention enables the creation of renderings for various interactions with physical objects. Typical interactions that are the purpose of the present invention include advantages of the physical object, comparison of the object to other similar or dissimilar physical objects, the operation, installation, maintenance, repair and replacement of a physical object. Such operations can be performed on a variety of target objects such as, for example, a printer (installing a cartridge), medical implant (surgical installation), industrial valve (replacing the packing), and so on.

It should also be understood that in accordance with one aspect of the present invention, a realistic rendering of such interactions requires a detailed understanding of the nature of such interactions.

The documentation that is collected in accordance with this step of the present invention should enable this detailed understanding of the nature of the target interaction in particular.

The documentation may consist of videotapes, printed documentation, e-mails, text files and so on. Obtaining this documentation is generally important, otherwise the rendering produced in accordance with the present invention, may be incorrect or may not reflect the way the procedure is performed, or the interaction that actually occurs.

A particular form of documentation that can be particularly useful is a video recording of the interaction or procedure, as shown by an individual who is particularly knowledgeable in the details of the interaction or procedure. The video recording preferably consists of a detailed explanation of each and every step of the interaction or procedure. Where possible, the recording should show (with appropriate close-ups where required) the interaction or procedure in association with the target physical object or objects.

The individual is preferably trained in the benefits of the present invention before creating the videotape recording. The individual is further solicited to share “tricks of the trade” type information.

The individual is also preferably directed to make comments based on what is appropriate in making a three-dimensional rendering.

The documentation gathering step is designed to collect knowledge regarding how information about a physical product or process is currently communicated by an organization. For example, this communication of information about a physical product or process may be part of a particular sales process. An example of such a sales process are sales activities engaged in by medical device manufacturers to promote their products. These activities include training sales representatives regarding the functioning and surgical installation of a device; the effect over many years on a person's mobility as compared to the use of a competing device; presentation of the device to doctors and operating team; and communication with a patient by a doctor regarding functioning of the device and a surgical process, for example. Other examples include similar activities that involve illustration of installation of a toner cartridge into a printer, or repair of a carburetor in an automobile. In each case, the common element is a real life physical object or procedure involving a physical object that is known. The present invention enables creation of three-dimensional renderings of such physical objects or a procedure involving a physical object. These renderings enable creation of electronic interactive presentations that accurately reflect reality.

Further to this initial goal of documentation gathering, a detailed understanding of communication needs that currently exist must be identified. In industrial manufacturing, communication generally exist between the manufacturer and the sales representative, the sales representative and the purchaser, and purchaser and the end user. Another aspect of understanding communication issues is comprehending the specific purpose for the communication, and where communication breakdown is happening. A manufacturer may, for example, wish to use an interactive three-dimensional rendering to particularly focus on the improvements of its device over a competing device. All of these communication issues are identified and documented during the documentation gathering step.

Examples of communication needs in relation to an orthopaedic implant where the manufacturer needs to communicate to the sales representative include: (a) the surgical procedure, (b) the features and benefits of the surgical instruments and the related procedure that will reduce potential surgical problems, (c) the features and benefits of the implant for the patient, (d) the relative advantages of the implant when compared to competitors' implants, (e) the particular physiological indications of when the implant is appropriate, and (f) the effect on the patient of the implant over a period of several years.

The sales representative wishes to communicate this same knowledge to the doctor and the operating room staff. The doctor may selectively transmit some or all of this knowledge to the patient.

Unreliable communication between the manufacturer and the sales representative occurs for many reasons. For example, the sales representative has limited training or experience with the environment wherein the product is used, unfamiliarity with common knowledge in the industry, or general knowledge required for the installation of the product. In the medical implant example above, these problems manifest themselves with sales representative having limited knowledge of anatomy and surgical procedures. Communication can fail when there is limited time for communication to occur.

Issues of communication occur during installation for a variety of reasons. In the medical device implant example, surgery is the installation procedure. The surgeon may not have positioned an instrument correctly, and the sales representative is required to explain how to position the instrument. Instructions provided by the sales representative may include “rotate left and invert the implant”. Further communication may need to be made to a nurse on how to assemble an instrument or the implant.

Issues when communicating between the purchaser and the end user has potential problems as well. Using the medical implant example, the surgeon may have poor verbal communication skills, and the patient may have limited understanding of human anatomy. Communication in this example may have legal implications as the surgeon may be legally responsible for ensuring that the patient understands the surgery about to be performed prior to consent.

It should be understood that in one aspect of the present invention, the documentation gathering focuses on benefits of using the three-dimensional renderings as a sales tool. This is achieved by focus on particular communication issues related to the sales process, and then linking these communication issues with particular aspects of the physical object, or procedure involving a physical object.

It should also be understood that in one aspect of the present invention, the documentation gathering focuses on benefits of using the three-dimensional renderings as a product support tool. This is achieved by focus on particular communication issues related to the product support process, and then linking these communication issues with particular aspects of the physical object, or procedure involving a physical object. For example, the introduction of a new type of consumer product such as a shaver may introduce support problems such as cleaning the shaver. The use of interactive three-dimensional renderings could simply communicate answers to consumer questions.

In another aspect of the present invention, the documentation gathering focuses on benefits of using the three-dimensional renderings as a training tool. This is achieved by focus on particular communication issues related to training issues, and then linking these communication issues with particular aspects of the physical object, or procedure involving a physical object. For example, pumps used in petro-chemical plants may need repair and maintenance. It is not uncommon for these plants to be in cold environments such as northern climates. To train the service representative prior to actually going into the cold to perform the maintenance the use of interactive three-dimensional rendering could shorten the preparation time.

Story Board

In another aspect of method of the present invention, as a further aspect of establishing the requirements for a three-dimensional rendering of the present invention, a “story board” of the interaction or procedure is created.

The storyboard, as this term is used in this disclosure, is designed to address one or more of the communication issues found during the documentation gathering. This generally involves documenting the interaction or procedure as several individual steps. For example, each step is described as the movement of a single object and the object(s) it interacts with. For example, the removing of a lid from a jar could be broken down into two steps of (1) turning the lid of the jar, and (2) removing the lid from the top of the jar. With each step, descriptive text is associated and a list of the objects involved. The descriptive text is used to explain what should happen visually in simulating the interaction or procedure.

A particular form of documentation that can be particularly useful in developing the story board is a mock-up created using the client computer product of the present invention, which is detailed below. The mock-up includes an initial description of the various functions to be included in the client computer product, as well as the interactions with three-dimensional renderings that the client computer product will support. The mock-up may also include further details regarding functions available through the client computer product, for example, access to specific data, access to translations of data, product information, sales information and so on.

The mock-up allows a customer or a subject matter specialist to have a better understanding of the storyboard. The mock-up can include but is not limited to a visualization of the software navigation of the client computer product of the present invention and sample three dimensional renderings.

Validation

It is generally preferable to have one or more persons familiar with the physical object or procedure to review the storyboard documentation. This step can be seen as a further step following the creation of the storyboard or in fact a parallel step involved in creation of the storyboard.

The review determines if all the required steps, knowledge, and objects are correctly identified. Any errors found by this person are subsumed in an amended storyboard for use in the next steps of the present invention described below.

The validation process focuses in particular on the communication issues identified above to ensure that the storyboard addresses these issues in an advantageous fashion.

Component Specification

It is preferable during this step to identify each of the three-dimensional renderings that must be created in order to accurately represent the real world physical object or procedure based on the story board. It is important to note that in contrast to prior art solutions, the specification of the components of a physical object or procedure involving a physical object occurs based not on the physical attributes (or a physical model of a physical object) but on the story board which includes the focus on the particular communication issues identified above. This results in creation of a three-dimensional rendering that better accomplishes the desired result.

Each physical object or procedure is preferably disassembled into component parts or steps involving physical objects or component parts thereof (even if they cannot be physically disassembled). For example, a chair can be divided into the following components: 4 legs, a seat, and a back.

The division of each physical object or procedure into component parts or steps is generally used in the organization of the imagery for the purpose of creating three-dimensional renderings in accordance with the present invention. This also generally aids in better understanding the scope of a particular modeling and rendering project, in accordance with the present invention.

For example, the surgical installation of a medical device can be disassembled into the principal steps of the surgical procedure where illustration thereof to an audience is required. In relation to each such step, the physical object i.e. the medical device can also disassembled into its constituent parts.

Part of the component specification step is determining which of the constituent elements of a physical object will be modeled (as explained below) and which will be represented using a digital image. This choice depends on what the customer or subject matter specialist needs to represent, having regard to the story board. In relation to the medical device example, physical elements of particular importance that move, or are vertically elevated are generally modeled instead of represented using a digital image, for enhanced real life presentation.

The component specification is used as input in a number of subsequent steps such as the “Modeling Decision”.

### Design for Three-Dimensional Rendering

In accordance with one aspect of the invention, the second step consists of establishing the design for a particular three-dimensional rendering described herein.

It should be understood that creation of interactive three-dimensional renderings in accordance with the present invention involves the use of different modeling techniques and then combination of the product of such techniques to form a 3D model. Then, this 3D Model is animated to create the three-dimensional rendering of the present invention. This animation can also involve different computer processes.

The creation of a three-dimensional rendering of this invention involves design choices involving selection between such modeling techniques and computer processes. The selection is made with a view to achieving a three-dimensional rendering that addresses the objectives set out above, including in particular the communication issues. This selection is guided in particular by the requirements for the three-dimensional rendering described above.

Modeling Decision

The design of the three-dimensional rendering therefore first involves a modeling decision.

It is generally preferable to specify the parameters for modeling each object, in accordance with the method described herein. This permits to account for physical differences between different objects. For example, objects with surfaces that change in only one plane at a time (i.e. having a flat surface) and objects whose sides meet a sharp angle (e.g.: cardboard box) are generally referred to as non-organic objects. Surfaces which change in two planes at once (e.g.: curved such as the back window of a VW beetle or a human brain) are generally referred to as organic surfaces.

Generally speaking, objects manufactured with stamping techniques are considered non-organic, while natural objects and objects created with extrusion manufactured techniques are classified as organic.

From a project management perspective, it is generally desirable to reflect the estimated time required to model each object, in accordance with the present invention.

Animation Decision

The design of the three-dimensional rendering also involves an animation decision. Each interaction or movement in the storyboard is then reviewed for the type of animation to be used. “MATRIX” animation and “MORPH” animation are the two major techniques of animation generally used by those skilled in the art. These two methods are differentiated based on how object movement is represented.

The real world object is represented in software as a 3D model. The model can be thought of as a “mesh”. Images are attached and placed on the mesh to represent the texture of the object. The mesh is similar conceptually to an “electronic net” that is cast over a three-dimensional representation.

In MATRIX, animation all vertices in the mesh making up the object is transformed exactly the same. In MORPH animation, each vertex can be transformed independently.

The visual effect of each animation type can be different. In MATRIX animation, it appears that the object is physically moved or sized differently. In MORPH animation besides the physical movement and sizing it can appear that the object has taken a different form.

MATRIX animation is generally used to simulate mechanical type movements. For example: turning the top of a jar, the opening of a door.

MORPH animation, on the other hand, is generally used for natural movements, such as the movement of a string, the beating of a heart, or movement of water. Special software tools assist the trained technician in implementing the techniques for specific cases—for example the movement of clouds or simulating muscle movement in an arm. Examples of this specialized software include extensions to 3D STUDIO MAX™ such as DREAMSCAPE 2™ or HUMANIK™.

When there is a choice of rendering an object interaction with MATRIX or MORPH, it is generally preferable to use MATRIX. This is because MORPH animation generally takes more time of a person trained in the animation software application than the Matrix animation, requires more computer processing, and creates a more complex data file than MATRIX animation. Use of MORPH animation also generally complicates other aspects of the method disclosed, as stated below.

### Creation of the Three-Dimensional Data Object

In accordance with another step of the invention, a 3D model is created based on the steps described below. The 3D model is stored in a data file that is subject to animation in accordance with the next principal step described further below. The data file includes data produced in accordance with a variety of different modeling techniques selected based on the modeling decision mentioned above.

Image Creation

Digital images are generally used to provide surface detail of the target object, in accordance with the present invention. These same images are used to create non-organic components of the target objects. Digital images are generally created of the target components using a digital camera or a scanner.

When a digital camera is used, the images are generally created in a studio using reflected white light. For example, white light from four two-bulb units containing Philips F40DX 40 Watt fluorescent bulbs has been found to work well for the purposes of the present invention. These units are preferably placed above, below, behind and on either side of the object. The target object is preferably placed on a sheet of cool white material and all walls are in cool white to increase the reflected light.

When a digital camera is used, the component part is generally placed on a rotating board, called a turntable, marked with 45-degree angles. One flat surface (called the front) of the component is aligned perpendicular to the camera. The surface is then digitally acquired, and the turntable is turned clockwise through 360° stopping at each of the 45° positions and at any surface that is perpendicular to the camera. At each stop, an additional digital image is photographed. Additional stops are made and images acquired at all flat surfaces. Additional images may be acquired between the minimum stops to aid in the understanding of the component. While these additional digital images may not always be necessary, they can potentially increase the quality of the final three-dimensional renderings.

The component is placed face down on the turntable, and the same process is followed to acquire a second set of digital images.

Alternatively, the digital image of the flat surface can be obtained using a scanner. However, the scanner in relation to some objects is not practical.

To ensure correct digital image acquisition, the objects can also be held using 6-way holders.

In one particular aspect of the invention, the digital images prepared in accordance with this particular step can be improved by complying with the following guidelines.

1. The resolution of the image must be enough to support the specific quality of output required when the object is magnified during display. The amount of resolution is dependent on the specific targeted display technology and the requirements needed to meet the goals identified above during the Requirements for 3D Renderings step. To verify the resolution, the image can be displayed in a program like WINDOWS PICTURE™ or FAX VIEWER™.

2. The lighting colour is generally important in ensuring that it does not change the colour of the object in the digital images. If the colour of the object in-different images is inconsistent, the object will not look real. For example, the side of the car may look different than its top.

3. Reflected white light must be used to ensure that the digitally photographed surfaces do not reflect light sources. A model having a surface that uses a digital image containing a light source will not reflect reality. If the surface shows the light source, when the object is rotated, the reflection will rotate with the object. In real life, the reflection stays in one place while surface moves. (Imagine a rotating golf bail with a flashlight being shone on it. The reflection stays in the same place while the surface of the ball moves) Since what is being displayed is not what happens in real life, the resulting procedure will not look real and can be distracting to the viewer.

4. The depth of field must be minimised in the digital photographic process to simplify the modeling process. The camera needs to be as close to the object as possible with the minimum amount of optical zoom. Improper depth of field can cause skewing in the shape of the object in subsequent steps in the process.

5. An image of a face of an object should generally be included. If a small detail on a large object is required, for example a 1″ label on a door or the handle of a car, a separate image is required of the detail. The separate image is placed in position on the mesh of the object in subsequent steps in the process.

6. Distance between the object and the digital camera, and the resolution, is preferably kept constant for all of the digital images. However, this may not be possible for all objects, in which case other subsequent steps in the process described will generally compensate for this factor. Constant distance from the camera will result in a better quality three-dimensional rendering in less time in accordance with the present invention.

As stated earlier, the digital images are created using a digital camera, or a scanner. Examples of suitable digital cameras include Coolpix 990™ using the Macro-Mode focus setting with no flash. A reflection filter is preferably used. A 24 bit 600 DPI scanner can also be used.

Digital Image Adjustment Claim

Next, on a component by component basis, the digital images are preferably reviewed and corrected for clarity of image, focus, color correctness, and perspective. Images are identified as being used for creating object shape and/or for providing surface detail.

All the images are preferably scaled equivalently, i.e. the images that are to be adjusted such that when viewed with no scaling 1″ of an object will use the same number of pixels in all images. Images used only for surface detail will not generally have the scaling applied. The process of adjusting the image scale means expanding or shrinking the number of pixels in the image. Care must be taken in changing the resolution of the image, as it will affect the quality of the photo-realism.

Shrinking the resolution of the image reduces the quality as image data is removed. Expanding the resolution of the image relies on the application software to create additional pixels which may not accurately reflect reality. Small changes have little or no effect, large changes can have significant effects.

In each image, pixels that are not part of the object are preferably removed from the images.

Where a component has a hole, (like a donut hole) the pixels in the hole are generally removed.

Image manipulation software like ADOBE PHOTOSHOP 5.0™ can be used for this step.

It is recommended that no optimization of the digital image data be performed at this step as the optimization can reduce the quality of the three-dimensional rendering.

Non-Organic Modeling

Non-organic modeling occurs as follows in accordance with the present invention. This step will create photo-realistic three-dimensional representation of the non-organic objects of the non-organic objects.

For this step, A 3D Modeling program such as 3D STUDIO VIZ™ is typically used. Essentially, this step consists of creating a mesh of the real world object and placing the digital images referred to above on the mesh.

An image from the object is selected and is used as the reference image in the screen. Vectors are preferably drawn using the edges of the object as a guide until all its edges are defined. All the vectors are joined to create a mesh. The image map is preferably placed on this mesh aligning the edges of the object in the image with appropriate vectors. The digital image representing a right turn of the object is preferably placed in the background. New vectors are added to represent the new edges of the object. Previously created vectors are aligned with the object shown in the new digital image.

The above process is repeated until the all the images representing the object being rotated right through 360° have been used. The image representing the object being placed on its front is now placed in the background. The above procedure is repeated, using the second set of images. This connected mesh with the images is now called a 3D model.

An optimization is available to reduce the processing requirements of the final three-dimensional rendering. This optimization should only be applied to small surfaces that (a) are not generally considered key to the overall photo-realism of the object, (b) do not have identifying marks, and (c) have not been identified as key to the communication issues found during the Requirements For 3D Rendering step.

In cases where an object surface has a constant colour with no distinguishing characteristics (such as a logo, ID number, or instructions) a sample of the surface colour from the image is applied to part of the mesh of the object. For surfaces not important to the viewer for accuracy (as found in the “Requirements For 3D Rendering Step”) distinguishing characteristics like labels are attached to the mesh in the correct position.

This optimization generally reduces the processing requirements of the final three-dimensional rendering.

Organic Components Meshing Preparation

In this step, the organic components have a mesh physically drawn on them and then digital images of the mesh are used for the modeling process. The meshing process involves drawing multiple colored lines on the main curved surfaces of the object using the following procedure. One of the object faces is designated as FRONT, then vertical and horizontal lines are drawn on the object to make a grid. Lines are only drawn on the object where they can be seen from the FRONT. When a surface feature exists with in a grid square, lines from the opposite corners are drawn so that a line will go over the surface feature. The procedure is repeated using unique colors for the

TOP view, BOTTOM view, BACK view, LEFT view, and RIGHT view. The intersected lines create patches. Each patch preferably has a maximum of four vertices, with three being preferred. Additional lines need to be drawn to make sure no more that four vertices are preferably part of a patch.

While three colors are generally the minimum number required, using six colors to draw the lines simplifies later steps in the process. Selecting colors for adjacent sides, colors that are farther apart on the color wheel further simplify other steps in the process. To reduce the amount of mesh lines, it is generally sufficient to outline extrusions but not indentations. To decide if it is necessary to draw a line on an extrusion, the extrusion is viewed from the top, bottom, left, and right. If the edge of the extrusion is seen in silhouette, then the edge generally needs to have a line drawn on it.

A set of digital images is created of the object with the mesh drawn on it as described in the Image Creation step.

The step described herein enables the creation of three-dimensional rendering of an object having the correct shape. The number of lines drawn on the object is directly related to the accuracy, quality and complexity of the final result. It is generally preferred that the minimum number of lines be drawn to meet the quality requirements as described above.

Organic Modeling

Each component is preferably modeled using the digital images containing the mesh drawn on the object, provided in the manner described above. The front organic model image is presented in the background. Vectors are preferably created mapped to each line on the object. Vectors that intersect are joined and these joining points are called vertices. All the vectors together form the mesh.

To reduce errors and to simplify other steps, the color of the vector should generally match the color of the line on the object.

Using a single image, new vectors are only adjusted in the X and the Y axes, but not in the Z axis. A second or still other images are required to correctly set the Z value. An image of the object (without the lines) is mapped to the created surface.

The image representing the object turned to the right is preferably placed in the background. The new image will show new lines and changes to previously drawn vectors that map to the lines drawn on the object. The changes in the previously drawn vectors are due to the Z co-ordinate of the line. Previously drawn vertices will generally require that their object-z-plane values be adjusted. The new vectors are accordingly created.

These steps are repeated until all the organic modeling images have been used. The adjusted digital images are placed on this mesh in a manner that is known.

A 3D modeling program such as 3D STUDIO VIZ™ is generally used in this step also.

Object Verification

This step is used to verify the accuracy of the 3D model representing the physical object.

The components of the object are merged to a single data file and the final 3D model is created in accordance with the steps outlined above. This data file is exported to a known presentation facility such as CYCORE DESIGNER 5.3 ™, preferably with no optimization.

To enhance the verification experience, simple animation representing component movement (e.g: scissors open/close, a screw turns) is generally added.

One or more persons trained in the real world object validate that each object is a suitable photo-realistic three-dimensional representation of the object. Specific checks can include colour accuracy, movement accuracy, component shape accuracy, and relative scale accuracy checks.

### Animation of Three-Dimensional Object

In another aspect of the invention a further step in creating three-dimensional renderings is animation of the 3D model to produce the three-dimensional rendering.

Component Animation

The object interactions as specified in the storyboard are implemented using the 3D model verified in the Object Verification step described above.

Two types of animation are generally used (as stated earlier): MATRIX and MORPH animation. Again, in MATRIX animation, the entire component is translated and/or rotated; and in MORPH animation, the vertices on the mesh that make up the actual component are moved. Depending on the nature of the required movement, one or both animations are used. MORPH animation is used when then there is a requirement to change the physical shape of the object, otherwise MATRIX animation is used. Examples of when MORPH animation would be used is to simulate the movement of a string or the movement of a piece of paper through rollers, or the separation of a skin when a scalpel slices through it.

Once the animation is completed, an animation specification is produced. An important part of the animation specification is the animation frames that the component movement is performed in.

The MORPH animation is generally done using a modeling program such as 3D STUDIO MAX™, and the MATRIX animation is done generally using a modeling program or presentation software such as CYCORE DESIGNER 5.3™.

Procedure Animation

Next, the viewing position and viewing logic are preferably added in accordance with the storyboard step, established as set out below. These viewing angles and viewing logic are described herein as “procedure animation”.

The viewing position (sometimes called the camera position) refers to the view of the interaction and the magnification of the procedure. The viewing position is generally changed during a procedure to assist in highlighting specific features of the procedure.

The viewing logic includes such things as the capability to enable a procedure step to be repeated, making visible or invisible different objects, or moving non-essential items out of view.

Animation generally occurs in accordance with a predetermined Animation Procedure that generally includes the various desired components movements, a function to begin the animation, the optimum camera movements, and any control logic. Major capabilities include the ability to randomly display a particular step and to sequence through all the steps from beginning to end. Included could be parameters to allow the interactions to be viewed with modifications. For example specific positions (e.g.: Top, bottom, etc).

During this step, one or more persons trained in the real world object may provide feedback on the interactions as presented and suggest changes that are in variance to the storyboard.

Coding of Three-Dimensional Rendering

In yet another aspect of the invention, the three-dimensional renderings are coded in a manner that is known so as to inter-operate with a known web browser and a presentation utility such as CYCORE's CULT3D™. The result is the creation of a three-dimensional rendering that addresses the particular communication issues identified during documentation gathering.

Procedure animations described above generally include programmed logic elements, provided in a manner that is known. These logic elements generally enable interaction of the three-dimensional renderings with functions provided to an application programming interface, and in particular the run time application programming interface described below.

These Logic Elements Generally Include:

1. A unique identifier (called a function) for each animation procedure.

2. Parameters to vary the presentation of the procedure. For example, the speed of execution, or the viewing position. A parameter can be used to identify what step in the animation procedure should be executed.

These logic elements are provided to the three-dimensional renderings created in accordance with the process described. These logic elements are also provided to the rendering database described below. The result of the foregoing is a function to rotate a three-dimensional rendering will have the desired effect.

Other modifications to the present invention are contemplated. These include making use of automated tools for the creation of the mesh, different animation techniques other than MATRIX or MORPH, automated digital image creation, automated digital image adjustment, and techniques that combine the digital image creation with the mesh creation.

### System

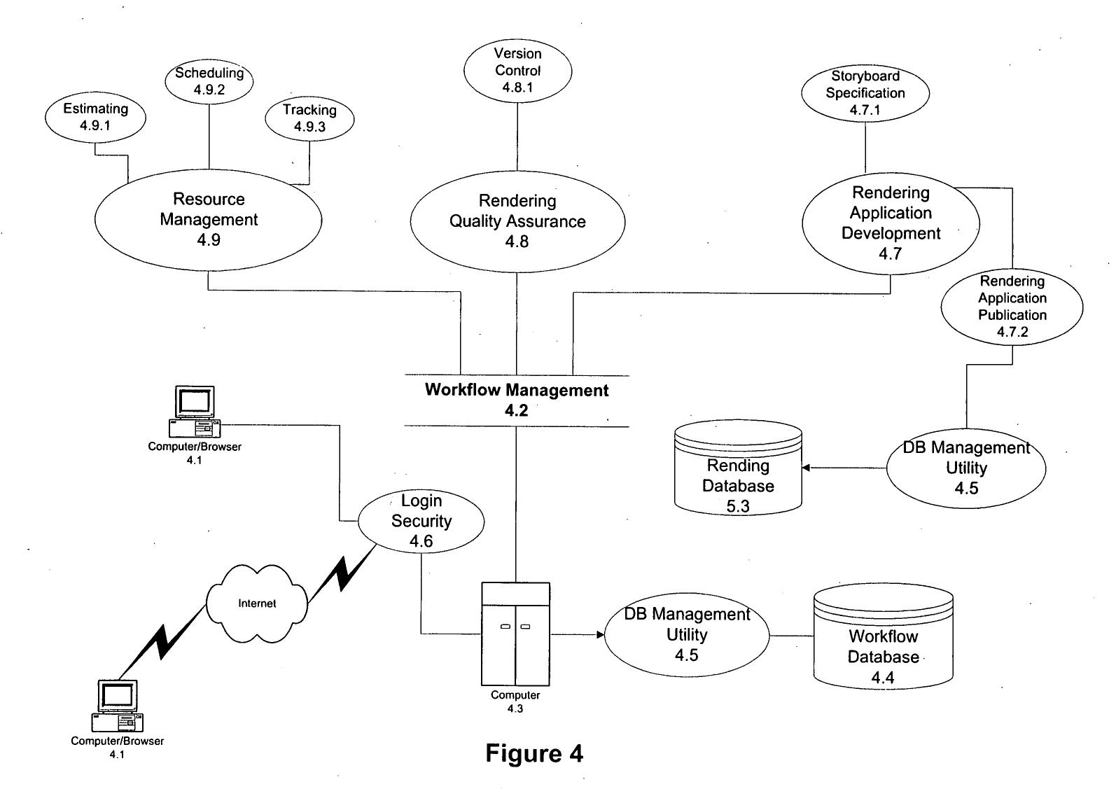

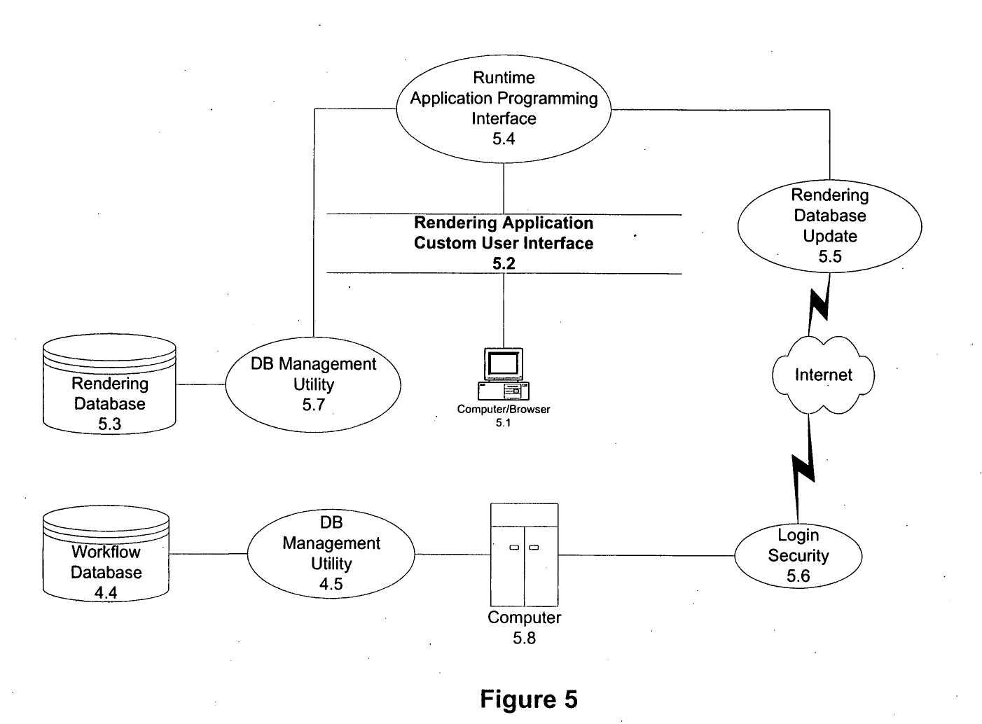

The system of the invention is best understood as (1) a system for creating the interactive three-dimensional renderings of the present invention; and (2) a system for enabling the presentation of, and interaction with, the three-dimensional renderings of the present invention. The first system described is generally illustrated in FIG. 4 and is referred to herein as the “Workflow Management System”. The second system described is generally illustrated in FIG. 5 and is referred to herein as the “Rendering System”.

Each of the Workflow Management System and Rendering System consists generally of a known computer (4.1 and 5.1). The computer may include a server computer, a network station, personal computer terminal, embedded computer, set-top box or any other computer device that is adapted to process instructions in accordance with the functions of the computer application (4.2 and 5.2) of the present invention.

The present invention generally includes a computer application (4.2 and 5.2) loaded on a computer or server (4.3 and 5.1). The computer application is generally linked to a database (4.4 and 5.3). The computer application (4.2 and 5.2) includes a communication facility (not shown). The communication facility enables communication as between the server or computer and the remote computers illustrated in FIGS. 4 and 5. The server or computer (4.3 and 5.1) and the remote computers are generally connected via the Internet or a LAN in a manner that is known.

The databases (4.4 and 5.3) of the present invention are known relational databases that enable searches across the various documents stored to the databases (4.4 and 5.3).

The computer applications (4.2 and.5.2) illustrated in FIG. 4 and 5 includes a database management utility (4.5 and 5.7) that is linked to the databases. The database management utility (4.5 and 5.7) enables the management of the database processes described herein. All files and items in the database will follow a set of standards that will ensure consistency through the various procedures. Included in the standard will be set of measurements.

### Workflow Management System

The computer product of the Workflow Management System is best understood as a computer utility that enables the functions particularized herein.

The remote computers (4.1) run a known browser or some other tool for sending and receiving data as part of the, process for creating three-dimensional renderings described herein.

Loaded on the computer (4.3) is the computer application (4.2) of the present invention which is best understood as a workflow management facility, as illustrated in FIG. 4. Users of the remote computers log in to the computer (4.3) by providing predetermined login information to the login security facility (4.6), which is provided in a manner that is known. By logging in to the computer (4.3), users of the remote computers (4.1) gain access to the functions of the workflow management facility (4.2) described below. These functions enable the creation of three-dimensional renderings in accordance with the method of the invention.

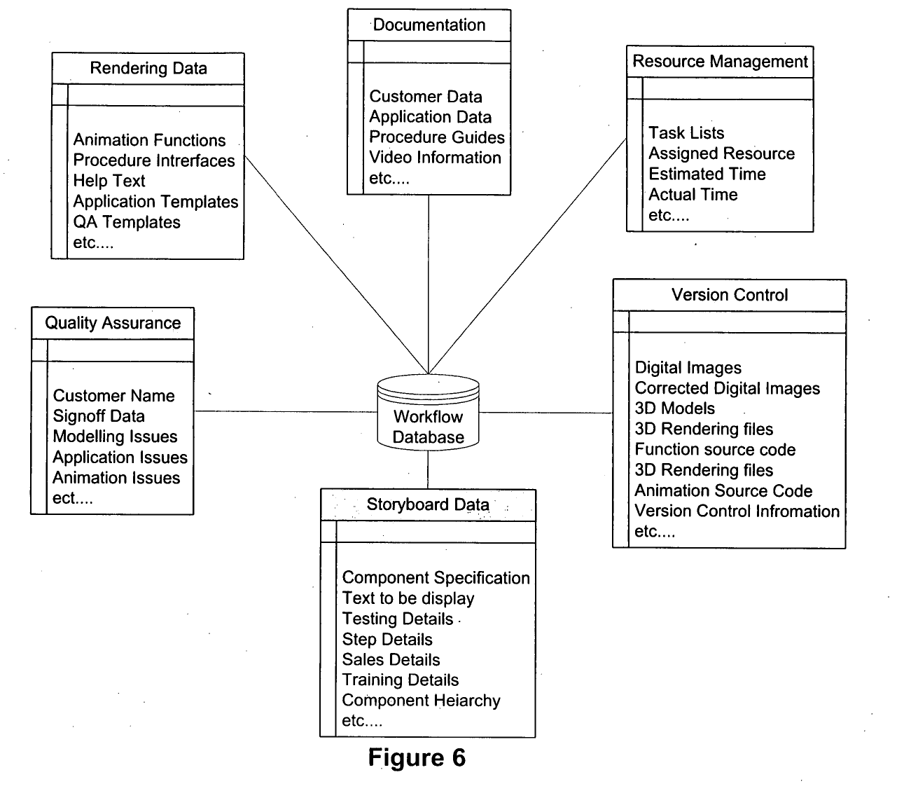

The database (4.4) of the present invention will enable the various individuals involved in the workflow to access data from, and store data to, the database in the context of the creation of the three-dimensional renderings. The contents of the database (4.4) as it relates to the Workflow Management System are best illustrated in FIG. 6.

In one aspect of the Workflow Management System of the present invention, the computer application thereof includes (1) Rendering Application Development Facility; (2) Rendering Quality Assurance Facility; and (3) Resource Management Facility.

### Rendering Application Development Facility

The rendering application development facility (4.7) is best understood as a computer application for developing the rendering application (5.2) described below. The rendering application (5.2) enables the presentation of three-dimensional renderings, and interaction therewith. Based in part on the requirements defined in accordance with the process described above, a set of requirements are established for the operation and interface attributes of the rendering application (5.2).

The rendering application development facility (4.7) assists in the relatively rapid development of a rendering application (5.2) that meets the requirements of a particular customer or subject matter specialist in relation to the presentation of, and interaction with, the three-dimensional renderings of the invention.

One particular aspect of the rendering application development facility (4.7) is a storyboard specification facility (4.7.1). The storyboard specification facility (4.7.1) enables an operator of the system of the present invention to establish the components (i.e. three-dimensional renderings data objects thereof), specific animations of such components, and organization of the above in relation to the establishment of a particular three-dimensional renderings to be delivered to the rendering application (5.2).

The storyboard specification facility (4.7.1) is organized into utilities that gather the information structured on the types of three-dimensional renderings that are generally expected by the rendering applications (5.2). The known types of three-dimensional renderings include informative three-dimensional renderings, operational three-dimensional renderings, and testing three-dimensional renderings.

One aspect of the rendering application development facility (4.7) is the specification of functions that are made available to rendering applications (4.2). The functions direct the execution of the three-dimensional renderings. There are several classes of functions available. (1) Functions that are specific to a specific three-dimensional rendering; (2) Functions that are appropriate to all three-dimensional renderings; and (3) Functions that are appropriate only at certain times, An example of a specific function would be “Open-Doors” which only makes sense to an object like a car or a house. An example of a function that would always be appropriate at-all times is the “View-From-Top” function. This function would move the object so that the object is viewed from the top. An example of a function that is only appropriate at certain times is the “Replay-Current”. This function would only be appropriate for a three-dimensional rendering that has procedure steps associated with it.

A further aspect of the functions is that they can be used to synchronize the operation of multiple three-dimensional renderings, a three-dimensional rendering and a digital video, a three-dimensional rendering and digital audio, or any other presentation media. For example, the synchronization of two three-dimensional renderings could be use to demonstrate the effect of two different spinal implants on a patient over time.

Selection of such functions then enables an operator of the system of the present invention to customize the rendering application (4.2) by selecting specific functions thereof and by loading particular parameter data (text, function descriptors etc.) to the database (4.4).

Informative three-dimensional renderings are organized to provide information about a real-world object, operational three-dimensional renderings are designed to provide step-by-step operation about the real-world object, and testing three-dimensional renderings are designed to verify an individual's knowledge about a real-world object and or related procedures.

One aspect of the storyboard specification facility (4.7.1) is that in one aspect thereof it has different utilities for each of the different types of three-dimensional renderings. For an operational three-dimensional rendering the storyboard specification facility (4.7.1) generally begins with the definition of one or more procedures. The details of the procedure include the definition of one or more steps in the procedure. Discreet information is gathered with each step. An example of a procedure is the installation of a printer cartridge in a laser printer or a surgical procedure for implanting a prosthetic knee. Examples of the information gathered include the three-dimensional objects in the step, a title for the step, text describing the step, an audio commentary about the step, installation notes, what functions are available during the step, and related visual images. Each piece of information will generally be gathered in all the languages the rendering application is required to be presented in. Examples of functions include positioning (e.g.: top, bottom), rotation, magnification, and repeat.

For informational three-dimensional renderings, the storyboard specification facility (4.7.1) generally begins with the specification of the three-dimensional rendering. It then details the objects and types of information and the functions available. An example of an informational rendering application is one where the features and benefits of a product are presented. Detailed information about each feature and-benefit of the product will be gathered. For each feature a function can be assigned that will cause the three-dimensional rendering to demonstrate the feature. For example, if the informational rendering application was being applied to disc brakes and a feature of the disc brakes was anti-locking. A function associated with the feature would cause the three-dimensional rendering to initiate a demonstration of the anti-locking mechanism in operation.

Another example of an informational rendering application is one where brain tumours are explained. Examples of functions would include the display of the different parts of the anatomy. Another function is the display of an MRI image of with a representation of the slice is super-imposed on the three-dimensional rendering.

For testing rendering applications, the storyboard specification facility (4.7.1) generally begins with the specification of a series of test questions. There are a number of different test question types, which include but is not limited to multiple choice, specific answer, true or false, matching, sequencing, or likert. These are explained below.

For each type of question, question details such as the question text, the answer, help information and three-dimensional renderings are provided. Functions are associated with each of the questions to enable the questions and results to be gathered.

An aspect of the multiple choice questions discussed is, a function that will cause the three-dimensional rendering to present different variations of the procedure, but where only one of the presentations will be considered correct. This function will return to the rendering application the correct answer in a manner that is known. The rendering application will record the correct choice and selection entered by the user.

An example is to test a student's understanding of the playing of a musical instrument. A sound is played, and the keys on a three-dimensional rendering of an 88 key piano are depressed in synchronization with the sound. For example, in one rendering, the keys depressed correctly match the sound played, in another three-dimensional rendering the keys depressed are an octave above, in a third three-dimensional rendering completely the wrong keys are depressed.

A specific answer question is when an individual provides a specific response such as a word, number or phrase. This aspect of the invention is best described with the use of an example. A three-dimensional rendering is created for a measuring device such as a calliper. The test question text will request the reading on the callipers. The function associated with the three-dimensional rendering will cause the three-dimensional rendering of the calliper to adjust in a known manner. The adjustment can be random or a from a pre-programmed choice of values. The viewer will be expected to interact with the three-dimensional rendering of the calliper to read the measurement. The function will return in a manner that is known to the rendering application the setting of the calliper. The rendering application will record in a known manner the actual value from the function and the value entered by the user.

In a True or False question, an individual indicates if the presentation is accurate. This aspect of the invention is also best understood by the use of an example. A soldier is presented with the procedure for assembling a rifle. The soldier is requested to indicate if the presented three-dimensional rendering is correct. A True answer indicates that the procedure is correct and a false answer is that the procedure is incorrect.

The matching question is designed to verify if an individual can identify a single entity in a set of entities. In its simplest form, the individual is presented with a three-dimensional rendering, and then requested to identify the same three-dimensional rendering in several other three-dimensional renderings. This aspect of the invention in a more complex form can best be understood by the use of an example. An automobile mechanic is presented with a three-dimensional rendering of a motor presenting a mechanical failure. He is then requested to review several three-dimensional renderings of repair procedures, and select which repair procedure would be most appropriate.

The sequencing question is designed to find out if an individual can sequence a number of items. In its simplest form, a number of steps in a procedure are presented and an individual is asked to identify the correct order of the steps. An aspect of the sequencing question type in a more complex form is best understood by the use of an example. An aerospace maintenance engineer is presented with a major failing of an airplane and several component failings which occur because of the failing of another component. The engineer is requested to sequence the different component failings which lead to the airplane failing.

Likert questions generally do not have a correct answer but are used to discover personal preferences for an individual. The likert question type is best understood by the use of an example. A homemaker is presented with a number of three-dimensional renderings each representing a variation in a new type of appliance such as a steam iron. The three-dimensional rendering presents the different styles and different ways of putting the water into the iron. The homemaker is requested to compare the different three-dimensional renderings and identify which three-dimensional rendering represents the homemaker's preference. Another example is when the rendering application is used for advertising purposes. A traditional advertising campaign (newspaper, television, radio) portion generates interest in the consumer to visit the three-dimensional rendering on the Internet to experience the product in an interactive environment. The likert question could be used to identify the priority of the features of the product.

Another aspect of the storyboard specification facility (4.7.1) is the interaction with the resource management facility (4.9). The storyboard specification facility (4.7.1) identifies specific deliverables that need to be created. For example, each object identified in a storyboard step becomes an object for which component specifications must be created. Each component must then have digital images created and 3D models created. Each digital image must be adjusted. Each function identified must have the animation and the appropriate coding of the three-dimensional rendering created.

In another aspect of the present invention, the rendering application development facility (4.7) enables the creation of a component hierarchy to be stored to the database (4.4). This generally includes a hierarchy data description enabling a three-dimensional object to be described as a hierarchy and as a system. For example, the hierarchy is inclusive while the system view includes items across the hierarchy. For example: car engine contains an engine block; the engine block contains pistons; and the pistons contain a piston head and crank.

In a system definition, the system is a collection of hierarchies. For example, the Drivetrain system contain the engine hierarchy, and the transmission hierarchy, and differential hierarchy.

One particular aspect of the rendering application development facility (4.7) is the rendering application publication facility (4.7.2) which is best understood as a series of utilities to create the rendering application system (FIG. 5) described below.

One aspect of the rendering application publication system (4.7.2) is a set of software utilities that create a rendering database (5.3) and populate it with known data stored in the workflow database (4.4). The rendering database (5.3) is merged with a custom user interface and the rendering application program interface (5.4) to create a rendering application (4.2).

One aspect of the rendering application publication facility (4.7.2) is a series of templates for different representative rendering applications. Selection of such a template then enables an operator of the system of the present invention to immediately have a rendering application that can be provided to users.

Another aspect-of the rendering application publication facility (4.7.2) is the creation of a mock-up of the application rendering application (5.2) which will demonstrate the integration of the custom user interface and data acquired by the storyboard specification facility (4.7.1).

Another aspect of the rendering application publication facility (4.7.2) is a utility that enables the creation of a printed documentation. This utility can be used to ensure that the interactive three-dimensional rendering and associated printed guides are consistent.

### Rendering Quality Assurance Facility

The rendering quality assurance facility (4.8) cooperates with the rendering application publication facility (4.7.1) to publish to a web site accessible via the Internet one or more web pages including the content to be reviewed by the customer or subject matter specialist, as well as related text explaining the parameters for review, fields for providing feedback, and if applicable check boxes that enable sign-off on specific items. The presentation is performed with a series of templates that can be used to present both work-in-progress and completed three-dimensional renderings. The rendering quality assurance facility (4.8) enables feedback and sign-off in this way on (1) 3D models, (2) three-dimensional renderings and (3) the rendering application.

Another aspect of the rendering quality assurance facility (4.8) is a facility whereby customer or subject matter specialist provides sign-off or feedback regarding deliverables that are part of the three-dimensional rendering workflow. In this first aspect of the present invention, the rendering quality assurance facility (4.8) creates a list of data objects in the database (4.4) for review by the customer or subject matter specialist. The list of data objects, in one particular aspect of the rendering quality assurance facility (4.8) is further linked with a series of fields for providing feedback on particular deliverables, or signing off on particular deliverables. Each item on the list becomes a deliverable that is passed to the scheduling facility (4.9.2).

In another particular aspect of the present invention, upon completion of the deliverables linked to the list of data objects described, the workflow management facility engages the computer (4.3) to send a message to the customer or subject matter specialist to log on to the computer. The customer or subject matter specialist is given a usemame or password to clear the login facility (4.6) to thereby access the workflow management facility (4.2).

The function of this aspect of the rendering quality assurance facility (4.8) is to engage the customer or subject matter specialist to consider whether deliverables meet base benchmarks and generate, based on the results of such assessment, further deliverables that are communicated to the resource management facility (4.9). This assessment generally occurs by creation of a list or questionnaire that operators of the present system are required to complete before a deliverable is considered finished.

The feedback that generally is provided by the customer or subject matter specialist include object benchmarks include such issues accurate shape, proportional size, color, surface detail, and position of detail. Three-dimensional rendering benchmarks include accuracy of the procedure and positioning of the viewing angle. Improvement benchmarks can include suggested improvements such as additional functions or an alternative viewing position. Rendering application benchmarks include consideration of textual descriptions or functionality not working correctly. Each item that does not meet the standard are passed to the scheduling facility (4.9.2) as changed items to be delivered.

Another aspect of the rendering quality assurance facility (4.8) is the version control facility (4.8.1) that is linked to the database (4.4). One aspect of this particular facility creates a log identifying each particular version of an electronic document that is stored to the database (4.4).

One aspect of the version control facility (4.8) is that the various-electronic documents created as deliverables are identified and accessed in a known manner through the database (4.4). For example these electronic document include the source files for the 3D models, the source code for the animation procedures, and the source code for the component animations.

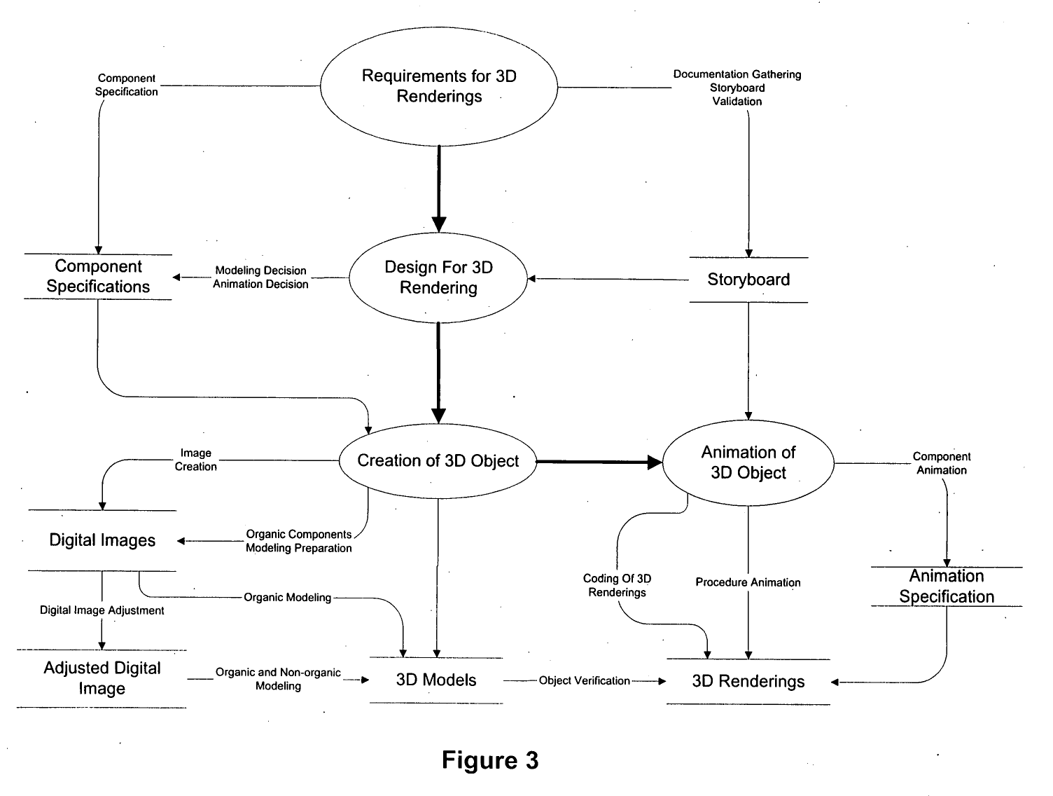

Another aspect of the version control facility (4.8.1) ensures that file dependencies implicit in the process described are explicitly linked and where necessary identifies where new files are required and new signoffs are required. The major dependencies and how they are effected by the process steps are presented in FIG. 3. For example, the three-dimensional rendering source files are dependent on the source files for the 3D models. And the 3D models are dependent on the source files for the adjusted digital images, and the adjusted digital images are dependent on the source files for the digital images.

The version control facility (4.8.1) is best explained with an example. If a change is identified that requires a new digital image, the version control facility (4.8.1) will identify the 3D models that need to be rebuilt, the animations that will need to be regenerated, and the publication of the updated rendering application (5.2) that will be published. Further, the customer or subject matter specialist will need to provide a signoff on the accuracy of a number of different items that are updated when a digital images have been changed. The 3D models will require the changed digital images to be reapplied to effected surfaces. This 3d Model will require a new signoff. Once the 3D model has been changed, any three-dimensional renderings that included the changed 3D model will need to be updated with the new 3D model. The customer or subject matter specialist will be required to review the changed three-dimensional rendering. Once the three-dimensional: rendering has been changed, then all the rendering applications dependent on the three-dimensional rendering will need to be reviewed. Depending on the extent of the change, it may be possible that the verification of the three-dimensional application to be considered to be a valid review for the 3D model and for the three-dimensional rendering. Each signoff is considered a deliverable and is provided to the scheduling facility (4.8.2) in a manner that is known.

Another aspect of the version control facility (4.8.2) ensures that files being changed or modified are only being modified in a controlled manner.

### Resource Management Facility

The resource management facility (4.9) of the present invention is best understood as a series of software utilities related to the creation of deliverables in relation to a particular three-dimensional rendering of the invention and the management of the people involved in creating these deliverables.

The resource management facility (4.9) of the present invention includes a scheduling facility (4.9.2); a tracking facility (4.9.3); and an estimating facility (4.9.1); as best illustrated in FIG. 4.

An example of how the resource management facility (4.9) works is best explained by an example. When the user of the rendering application development facility (4.7) selects a “BEGIN RENDERING APPLICATION” function or equivalent. This triggers the scheduling facility (4.9.2) to create a base set of deliverables for creating a rendering application. The first item in the deliverable set is the story board. The set of deliverables expands to include the steps described in the process of the present invention that would include the creation of a component specification. The rendering application development facility (4.7) creates further deliverables for each component that is part of a particular story board, in accordance with the process described.

Some of these deliverables require the creation of specific data files and loading of same to the database (4.4). Other deliverables require choices to be made such as for example the animation choice of the process described above.

Another example is when a change is made to a dependent file as described above in the version control facility. A set of changes to existing deliverables is generated. These changes are added to the deliverable set. Still more deliverables include having the customer or the subject matter specialist provide a signoff of work-in-progress, or have the customer or subject matter specialist provide a quality assurance report.

Still more deliverables include having assignments made to staff to create the deliverables.

In this way, the scheduling facility (4.9.2) is best understood as enabling the creation and management of multiple deliverables.

Another aspect of the resource management facility (4.9) is the prioritizing of the deliverables. As certain deliverables are dependent on other deliverables, the order of the deliverables are important, as individuals with certain skills can only create certain deliverables and therefore the deliverables can only be assigned to certain individuals.

Another aspect of the resource management facility (4.9) will allow notes and comments to be added to individual deliverables. These notes and comments can include directions and any special instructions.

Another aspect of the resource management facility (4.9) will provide reports about the progress and management of the creation of the rendering applications and any of its deliverables.

A still other aspect of the resource management facility (4.9) is the estimating facility (4.9.1) for enabling the rapid and relatively efficient creation of estimates and proposals regarding the creation of three-dimensional renderings in accordance with the invention. In its preferred mode, as each deliverable is created an automated estimate of the amount of working hours will be created. The automated estimate will be created with an algorithm that is known. The algorithm is based on the complexity of the deliverable and the length of time previous deliverables with similar complexity took.

Another aspect of the estimating facility (4.9.1) is the assignment of a deliverable to a specific person who is known to the workflow management system (4.2). The deliverable estimate may be adjusted automatically by the system based on an algorithm that includes experience the individual has had with a similarly complex deliverable. A properly authorized individual can adjust the estimate. Certain deliverables may not be made available to the assigned individual until the various dependent deliverables have been approved by the customer or subject matter specialist.

Another aspect of the resource management facility (4.9) is the tracking facility (4.9.3) for enabling the tracking of actual time spent on deliverable task by an individual. The actual time will be stored in the workflow database (4.4). Another aspect of the tracking facility (4.9.3) will use the supply of the actual times needed to create the deliverable to the estimating facility (4.9.1) to increase the accuracy of the automated estimates.

Typically a staff person will access the tracking facility (4.9.3) to review the deliverables assigned to them, and will be advised which is the next deliverable they are to create. The deliverable assignments will be updated by the workflow management system on a timely basis as deliverables change.

Another aspect of the estimating facility (4;9.1) will allow a properly authenticated person to manually adjust deliverables priorities and assignments.

Another aspect of the resource management facility (4.9) will be used to provide reports on the actual progress of creation of the three-dimensional rendering application versus the estimated times. For example, these reports could be used to provide billing information to a customer, identifying delivery date issues, or identifying the need for more resources.

Another aspect of the resource management facility (4.9) is the automatic escalation of when deliverables are not completed in the time allocated. For example, the escalation can be provided through an e-mail sent to the appropriate manager or through a automated telephone call.

### Rendering System

As stated above, another aspect of the present invention is a rendering system as illustrated in FIG. 5. The rendering system includes a client computer (5.1) running a browser or some other tool for sending and receiving data as part of the process of interacting with the three-dimensional rendering. Loaded on a computer (5.1) is a rendering application (5.2), which generally consists of a custom user interface (5.2) for accessing, presenting and interacting with the three-dimensional renderings of the invention. This custom user interface (5.2) is provided in a manner that is known by implementing a browser compatible software application. An example would be an application whose source code is SHOCKWAVE™, JAVA™ or HTML™.

The rendering application (5.2) is then linked to a run time application programming interface (API) facility (5.4). The run time API facility (5.4) provides access to the rendering database (5.3). The rendering database in its preferred mode is linked to the client computer (5.1) and includes the various data files providing the three-dimensional renderings of this invention, data required to present and interact with these three-dimensional renderings (including interaction functions), related text, audio, language controls (including translations) and data to select preferences associated with the presentations and interactions. Alternatively, the rendering database (5.1) can be on a remote server computer and accessed via a LAN or an IP network (not-shown).

The run time API facility (5.4) is further linked to the workflow database (4.4) in order to obtain updates of data stored to the rendering database (5.3). One of the functions of the run time API facility (5.4) therefore is polling of the workflow database (4.5) to obtain such updates in a manner that is known.

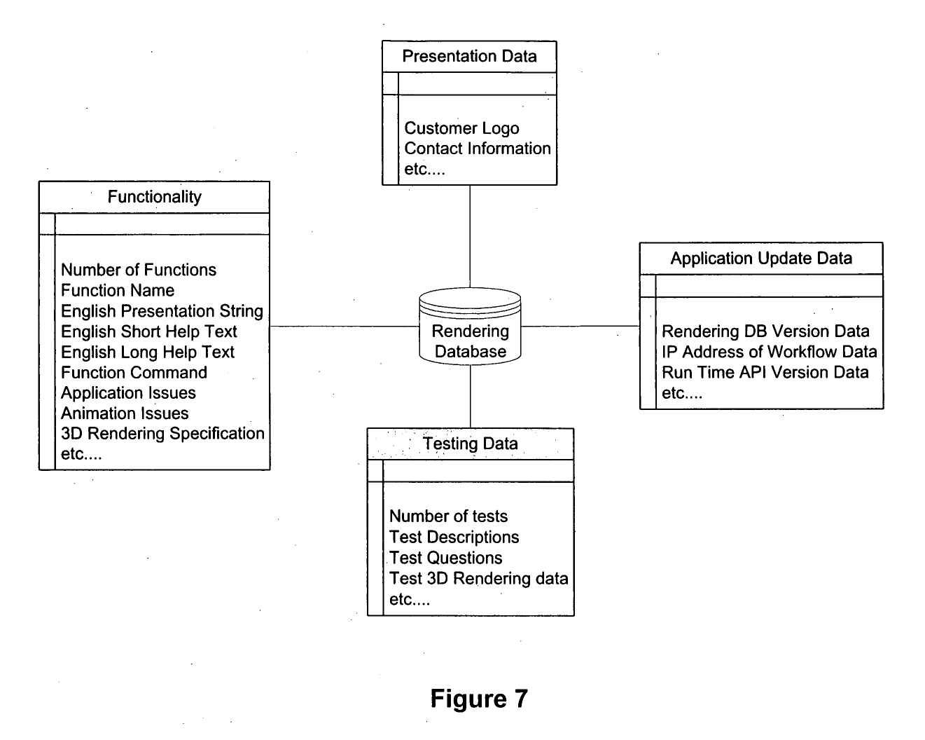

The rendering database (5.3) of the present invention will enable the custom user interface (5.2) to present information and functionality to the user in the context of a rendering application. The contents of the database (5.3) as it relates to the rendering application are best illustrated in FIG. 7.

The custom user interface (5.2) generally consists of a series of presentation functions and interactions (in the form of logic elements) directed to the three-dimensional renderings, established by the rendering application development facility (4.7) particularized above.

One use of such a custom user interface (4.2) is a training desk facility. which consists generally of a training tool for salespeople. In particular, the training desk facility consists of a series of training modules and testing modules linked to three-dimensional renderings of this invention. The training desk presents several training modules. Each module is a three-dimensional rendering with several steps. Each step includes several 3D models interacting with each other. A text area on the display presents to the user text that describes the particular step. Another text area presents informational notes about the procedure step. The user would be able to select one of many different running audio commentaries as well. A testing module provides verification that an individual has learned the procedure. An example of this usage would be a procedure explaining how to perform an arthroscopic repair of a rotator cuff. One module would provide a three-dimensional rendering for each of the instruments used. Another module would demonstrate how to close the tear. A further module would demonstrate how to insert an anchor and tie together the muscle. A final module would demonstrate how to create a stitch outside the body and insert it through a annular. An example of a testing module would be a module to test an individual's understanding of the correct placement of the anchor. In this example, the anchor must enter at a 60 degree angle at shoulder height. The individual would be presented with a three-dimensional rendering with the anchor at 45 degrees, another three-dimensional rendering with the anchor on the arm, and a third three-dimensional rendering with the anchor positioned correctly. The user would have to select the correct three-dimensional rendering. The results would be recorded.

One use of such a custom user interface (4.2) is a help facility which consists generally of information on how to perform a task with a consumer product. In particular, the help facility consists of a series of modules for different functions. The user selects which step to view, the three-dimensional rendering executes the specific step. In the Do-It-Yourself marketplace, manufacturers of products need to teach the consumer how to use the product to build something. For example, using a circular saw to build a deck. One module would be design the deck. Another module would be to measure the wood. Another module would explain how to change the blade on the saw. Another module would be the methods for cutting the wood.

Another such use of a custom user interface (4.2) is a help facility that is used internally to a company to help consumers calling into a help center. An example is a cellular phone help-center. New customers for cell phones may need significant support during the first few days. As the product line grows it becomes a challenge to support the customers in the new products. It is not unusual for a company to sell ten different handsets from four different manufacturers as well as a host of different service packages. Each handset is capable of about 150 different operational procedures such as installing the battery, answering call waiting, viewing the calendar and listening to voice mail. Training the customer support representative on all procedures for all phones is virtually impossible. Using a custom user interface (4.2) that provides the customer service representative a visual explanation along with the text that the customer service representative needs to say enables a single representative to be able to assist on an almost infinite number of products.

Another use of such a custom user interface (4.2) is a sales facility which consists generally of showing the features of a product with many moving parts. In particular, as the user selects a specific feature of the product, the product moves to demonstrate the feature and in another display area, a description of the benefits of the feature are described. An example of this use is in the mining equipment for foreign buyers. Mining equipment by its nature is large, heavy and expensive. To demonstrate the equipment in place is complicated and requires, a mine or a simulated mine. For example to demonstrate a mining shovel which weighs many hundreds of tons to a potential buyer thousands of miles away is only practical at a trade show or a site visit. Using the three-dimensional rendering even features such as the fill factor of the bucket, the track rail guides, and the size of the rollers can be demonstrated without travel.

Another particular aspect of the runtime API facility (5.4) is a text facility which defines the text that is loaded to the database (5.3) and linked to the remote computer (5.1) such that the remote computer (5.1) accesses such text, as further particularized below. The text facility further includes means for accessing different languages for the same text. This enables multi-language access to presentations of, and interactions with, the three-dimensional renderings of the present invention. The multi-language aspect of the present invention would allow instructions to be displayed in the official and common languages of that country.

Another aspect of the runtime API facility (5.4) is the gathering of user usage data when using the rendering application. Examples of the information gathered would include what product features were reviewed and in what order. For rendering applications designed for training, test result data would be gathered. This data would be stored in the rendering database (5.2) and provided to the workflow database when polled (not shown).

Another aspect of the runtime API facility (5.4) is linking the three-dimensional rendering to work in synchronization or sequentially with other applications. For example, a rendering application (5.2) is created to demonstrate a man's shaver. As the buyer interacts with each feature of the shaver through the three-dimensional rendering, the interaction is forwarded to a coupon application. As each feature is demonstrated the value of the coupon is increased. The user has the ability to print out the coupon for a price discount. Another example of this aspect of the present invention is to interface the features to a contest; As an individual views each feature, that individual would have an additional entry in the contest, or the contest could be viewing the features in a specific order.

Another aspect of the runtime API facility (5.4) is remote viewing and manipulation. Through the runtime API facility (5.4) two or more separate rendering applications can view and control the same three-dimensional rendering. In an example of a sales facility based on the invention, one rendering application (5.2) is designed for the purchaser of a construction tool such as a ride-on trowel and another rendering application (5.2) is designed for the seller of such a tool. As the purchaser adjusts the positioning, magnification and visibility of objects in the purchaser's three-dimensional rendering, the seller's rendering application (5.2) is adjusted similarly. Furthermore, the seller may wish to show the clutch mechanism on the ride-on trowel, and so adjustments that are made to the seller's three-dimensional rendering will adjust the purchaser's three-dimensional rendering. Another example is a help desk facility. A customer with a question would be able to adjust the customer service representatives three-dimensional rendering so as to help ask a question such as “What is this button for?”.

Another aspect of the runtime API facility (5.4) is a communication facility (non shown) provided in a manner that is known. The communication facility enables an individual using one rendering application to communicate with an individual using another rendering application. Utilities would include to allow one individual to highlight an aspect of the three-dimensional rendering and show the highlighting in another rendering application. Another utility enables contact between the individuals using the rendering applications using text, sound, and video.

Other modifications to the present invention are contemplated. Automatic generation of the deliverable lists which are forwarded via e-mail, automatic scheduling of timelines for completion of such tasks, expansion of templates for creating further custom interfaces, synchronized connections with other media such as video, audio, are all contemplated. Expansion of interaction to include video chat and other chat media is a natural extension of the invention. The movement and synchronization of the three-dimensional renderings with movement and synchronization of real life objects is also envisaged. Further types of test questions and different implementations of the existing test questions are also a natural extension envisioned. Associating an economic cost with each deliverable and generating overall cost estimates, actual costs, and profits are also envisioned. Management reporting and query based on these estimates are also envisioned. Extensions that are specific to certain industries are also envisioned.

What is claimed is:

1. A method for creating interactive three-dimensional renderings comprising the steps of:
(a) Defining one or more documents required to render a three-dimensional object, or process involving the three-dimensional object, the three-dimensional object or the process involving the three-dimensional object defining a three-dimensional rendering;
(b) Creating one or more documents in collaboration with one or more individuals with subject matter expertise related to the three-dimensional rendering;
(c) Creating a three-dimensional rendering based on the one or more documents; and
(d) Validation of the three-dimensional rendering by the one or more individuals with subject matter expertise.

2. The method claimed in claim 1, comprising the further step of defining parameters for determining the nature of the one or more documents required to render the three dimensional object, or process involving the three-dimensional object.

3. The method claimed in claim 1, comprising the further step of documenting a plurality of components, one or more processes, or one or more process/component combinations of the three-dimensional rendering.

4. The method of claim 1, comprising the further step of creating a story board for the process involving the three-dimensional object.

5. The method claimed in claim 1, comprising the further steps of:
(a) Documenting one or more digital images required to create the three-dimensional rendering, including digital images for relevant components;
(b) Preparing one or more models for creating three-dimensional digital images forming part of the three-dimensional rendering; and
(c) Preparing one or more three-dimensional digital images based on the one or more models.

6. The method claimed in claim 5, comprising the further step of defining a plurality of animation parameters for the three-dimensional rendering.

7. The method claimed in claim 5, whereby the digital images are prepared by doing one or more of the following steps:
(a) Defining desired resolution for the digital image;
(b) Defining lighting colour for the digital image;
(c) Using white light to reduce reflection;
(d) Minimizing the depth of field so as to simplify the application of the one or more models;
(e) Defining physical aspects of the three-dimensional objects for which a separate digital image is desirable; and
(f) Maintaining a substantially constant distance between the three-dimensional object and a camera device.

8. The method claimed in claim 7, comprising the further step of optimizing the digital image based on the requirements defined for that digital image.

9. The method claimed in claim 1, comprising the further step of creating a photo-realistic three-dimensional representation of a non-organic object, this further step including the steps of:
(a) Creating a digital mesh of the three-dimensional object using a meshing software utility; and
(b) Placing the digital images on the digital mesh in a plurality of areas of the digital mesh corresponding to a plurality of sectors defined on the non-organic object, thereby creating a three-dimensional model.

10. The method claimed in claim 1, comprising the further step of creating a photo-realistic three-dimensional representation of an organic object, this further step including the steps of:
(a) Drawing a physical mesh on a plurality of organic components of the three-dimensional object;
(b) Creating a digital image based on the physical mesh so as to define a digital mesh of the three-dimensional object;
(c) Creating a set of digital images of the organic components; and
(d) Placing the digital images on the digital mesh in a plurality of areas of the digital mesh corresponding to a plurality of sectors defined on the organic object, thereby creating a three-dimensional model.

11. A computer program product for creating interactive three-dimensional renderings, for use on a computer linked to a database, the computer program product being operable to define on the computer instructions for providing:
(a) A workflow management utility for managing the workflow related to the creation of interactive three-dimensional renderings, wherein the workflow management utility includes a storyboard specification facility that enables the establishment of the components of the three-dimensional object; and
(b) A rendering application development facility linked to the workflow management utility, wherein the rendering application development facility is operable to extract one or more data elements from work product created by the workflow management utility and define a three-dimensional rendering application based on such data elements.

12. The computer program claimed in claim 11, wherein the workflow management utility further comprises a rendering quality assurance facility, which is linked to a web publication facility to enable the publication of web pages that include three-dimensional renderings created by operation of the rendering application development facility, wherein the rendering quality assurance facility enables feedback and/or sign-off from one or more individuals on the effectiveness of three-dimensional models, three-dimensional renderings and/or the rendering application.

13. The computer program claimed in claim 11, wherein the workflow management utility further comprises a resource management facility that includes a series of software utilities for managing the workflow related to creation of three-dimensional renderings, wherein the software utilities include one or more of the following:
(a) A scheduling facility for scheduling activities related to the creation of three-dimensional renderings;
(b) A tracking facility for tracking the status of the activities related to the creation of three-dimensional renderings; and
(c) An estimating facility for providing cost estimates regarding the creation of three-dimensional renderings.

14. A computer system for creating interactive three-dimensional renderings, the computer system comprising:
(a) A computer linked to the database; and
(b) A computer application linked to the computer, the computer application including:
(i) A workflow management utility operable to manage the workflow related to the creation of interactive three-dimensional renderings, wherein the workflow management utility includes a storyboard specification facility that enables the establishment of the components of a three-dimensional object; and
(ii) A rendering application development facility linked to the workflow management utility, wherein the rendering application development facility is operable to extract one or more data elements from work product created by the workflow management utility and to define a three-dimensional rendering application based on such data elements.

15. The computer system claimed in claim 14, wherein the workflow management utility further includes a rendering quality assurance facility, which is linked to a web publication facility to enable the publication of web pages that include three-dimensional renderings created by operation of the rendering application development facility, wherein the rendering quality assurance facility enables feedback and/or sign-off from one or more individuals on the effectiveness of three-dimensional models, three-dimensional renderings and/or the rendering application.

16. The computer system claimed in claim 14, wherein the workflow management utility further includes a resource management facility that includes a series of software utilities for managing the workflow related to creation of three-dimensional renderings, wherein the software utilities include one or more of the following:
(a) A scheduling facility for scheduling activities related to the creation of three-dimensional renderings;
(b) A tracking facility for tracking the status of the activities related to the creation of three-dimensional renderings; and
(c) An estimating facility for providing cost estimates regarding the creation of three-dimensional renderings.

17. The computer system claimed in claim 11, wherein the rendering application development facility is operable to:
(a) Store the three-dimensional rendering to a database;
(b) Define information related to the processing of the three-dimensional rendering, including one or more of the following:
(i) Text related to the three-dimensional object, or the process involving the three-dimensional object;
(ii) Video related to the three-dimensional object, or the process involving the three-dimensional object;
(iii) Sound related to the three-dimensional object, or the process involving the three-dimensional object;
(iv) Images related to the three-dimensional object, or the process involving the three-dimensional object;
(v) Holograph related to the three-dimensional object, or the process involving the three-dimensional object; and
(vi) One or more testing questions related to the use of three-dimensional object, or the process involving the three-dimension object;
(c) Store such information to the database, such that the information is linked to a corresponding three-dimensional rendering; and
(d) Compile the three-dimensional rendering and the related information from the database so as to define a three-dimensional rendering application, by operation of the rendering application development facility.

18. The method of claim 1, comprising the further steps of:
(a) Storing the three-dimensional rendering to a database;
(b) Defining information related to the processing of the three-dimensional rendering, including one or more of the following:
(i) Text related to the three-dimensional object, or the process involving the three-dimensional object;
(ii) Video related to the three-dimensional object, or the process involving the three-dimensional object;
(iii) Sound related to the three-dimensional object, or the process involving the three-dimensional object;
(iv) Images related to the three-dimensional object, or the process involving the three-dimensional object;
(v) Holograph related to the three-dimensional object, or the process involving the three-dimensional object; and
(vi) One or more testing questions related to the use of three-dimensional object, or the process involving the three-dimension object;
(c) Storing such information to the database, such that the information is linked to a corresponding three-dimensional rendering; and
(d) Compiling the three-dimensional rendering and the related information from the database so as to define a three-dimensional rendering application, by operation of a rendering application development facility.
